(19) United States
(12) Patent Application Publication
(10) Pub. No.: US 2022/0178613 A1
(43) Pub. Date: Jun. 9, 2022

(54) ROTARY KILN HAVING SEGMENTED TEMPERATURE CONTROL CAPABILITY

(71) Applicant: JINGANG NEW MATERIALS CO., LTD., Shandong (CN)

(72) Inventor: Youyi ZHAO, Shandong (CN)

(73) Assignee: JINGANG NEW MATERIALS CO., LTD., Shandong (CN)

(21) Appl. No.: 17/437,050

(22) PCT Filed: Aug. 2, 2019
(86) PCT No.: PCT/CN2019/098962

§ 371 Date: Sep. 8, 2021

(30) Foreign Application Priority Data
Mar. 14, 2019 (CN) 201910190877.4

(51) Int. Cl. F27B 7/26; F27B 7/28; F27B 7/34; F27B 7/36

(52) U.S. Cl. CPC F27B 7/26; F27B 7/28; F27D 99/0033; F27B 7/36; F27B 7/34

(57) ABSTRACT

A rotary kiln capable of segmented temperature control includes a kiln body, a kiln head cover, a kiln tail cover, and a bottom base. A drive device is disposed between the bottom base and the kiln body. The kiln further includes a first fuel supply pipe having a supply segment, a connecting segment, and a rotating segment. The supply segment is fixedly disposed on an outer side wall of the kiln body. The rotating segment is disposed coaxially with the kiln body and connected to a fuel supply source through a rotatory joint. The supply segment communicates with the rotating segment through the connecting segment. Multiple groups of combustion components are disposed on the outer side wall of the kiln body, and a fuel inlet of each combustion component is connected to the supply segment of the first fuel supply pipe through a branch pipe.

### BACKGROUND

### Technology Field

The invention relates to a kiln, and more specifically, to a rotary kiln capable of segmented temperature control.

### Description of Related Art

In many production industries, such as building materials, metallurgy, chemical industry, environmental protection, and the like, rotary cylinder equipment is widely used to mechanically, physically, or chemically treat solid materials. The type of equipment is called a rotary kiln whose technical performance and operating conditions determine the product quality and production cost of the enterprise to a certain degree. The structure of a current rotary kiln is as shown in FIG. 8.

The kiln body is supported by supporting wheels, and a drive device drives the kiln body to rotate around the axis. A burner is located at one end of the kiln body and provides a heat required for establishing a temperature field in the kiln body. Materials are fed into the kiln body from a feeding port. As the kiln body rotates, the materials are thrown and tumbled in the kiln body while moving along the kiln body axis to a discharge end. Meanwhile, the materials undergo physical, chemical or material chemical changes under the action of heat. The burner is located at one end of the kiln body, so when the kiln body is long, it is difficult to control the temperature of each segment in a length direction of the kiln body, and it is difficult to consider all factors such as equipment productivity, temperature distribution in the kiln body, and firing atmosphere. The cross-sectional area productivity is low, and the energy consumption per unit of finished product is high.

To solve the problem, the patent application no. 2017218534981 discloses a swing kiln, and the kiln has a burner disposed on a side wall of the kiln body. Although the problem of inaccurate temperature control is solved, the kiln body can only swing but cannot rotate, which greatly restricts the use of the kiln body.

### SUMMARY

In view of the problems, the invention provides a rotary kiln with segmented temperature control. The kiln can not only implement segmented temperature control and make the control of the temperature field in the kiln more accurate, thereby implementing rotation. Compared with conventional rotary kilns, it has a wider range of applications.

The technical solutions adopted by the invention to solve its technical problems are as follows.

A rotary kiln capable of segmented temperature control includes a kiln body, a kiln head cover, a kiln tail cover, and a bottom base. A drive device is disposed between the bottom base and the kiln body, the rotary kiln further includes a first fuel supply pipe having a supply segment, a connecting segment, and a rotating segment. The supply segment is fixedly disposed on an outer side wall of the kiln body, the rotating segment is disposed coaxially with the kiln body and is connected to a fuel supply source through a rotatory joint, and the supply segment communicates with the rotating segment through the connecting segment. Multiple groups of combustion components are disposed on the outer side wall of the kiln body, and a fuel inlet of each of the combustion components is connected to the supply segment of the first fuel supply pipe through a branch pipe.

Furthermore, each of the combustion components includes a burner, a fuel inlet of the burner is connected to the supply segment of the first fuel supply through the branch pipe, and an air inlet of the burner is connected to a fan.

Furthermore, a burner brick disposed on a side wall of the kiln body is higher than an inner side wall of the kiln body.

Furthermore, a valve is disposed on the branch pipe.

Furthermore, a wheel belt and a driving gear ring are disposed on the kiln body. The wheel belt and the driving gear ring are both provided with through holes, and the supply segment passes through the through holes of both the wheel belt and the driving gear ring.

Furthermore, the rotating segment is disposed at a feeding end of the kiln body, one end of the connecting segment is connected to the rotating segment, and another end of the connecting segment passes through a side wall of the kiln body and is connected to the supply segment.

Furthermore, the rotating segment is disposed at a discharge end of the kiln body.

Furthermore, the connecting segment is disposed in the kiln head cover, and an end portion of the supply segment extends to an inside of the kiln head cover and is connected to the connecting segment.

Furthermore, the connecting segment is arranged in a radial direction.

Furthermore, first refractory bricks and second refractory bricks are disposed at intervals in the kiln body, and the first refractory bricks and the second refractory bricks together form a tooth-shaped structure.

The beneficial effects of the present invention are:

1. Multiple groups of combustion components are disposed on the side wall of the kiln body and distributed in the axial direction, which facilitates the control of the temperature field and atmosphere in the kiln body, and the control accuracy is improved.

2. The number, spacing and fuel flow of the combustion components can be adjusted according to the needs of temperature field control in the kiln body, accordingly the required temperature field can be achieved with the minimum energy consumption, and the requirements of equipment productivity, temperature distribution in the kiln and firing atmosphere are taken into account, which improves the productivity of the kiln per unit segment and reduces the energy consumption per unit of finished product.

3. The kiln can achieve both swing and rotary motion, which can meet the technological requirements for calcining different materials. Compared with the conventional rotary kiln, it has a wider range of applications.

### BRIEF DESCRIPTION OF THE DRAWINGS

FIG. 1 is a front view of a kiln.

FIG. 2 is a schematic view of an enlarged structure of part A in FIG. 1.

FIG. 3 is a schematic view of an enlarged structure of part B in FIG. 1.

FIG. 4 is a cross-sectional view of a section taken along line A-A in FIG. 1.

FIG. 5 is a schematic view of an enlarged structure of part C in FIG. 4.

FIG. 6 is a schematic view of a configuration of a first fuel supply pipe.

FIG. 7 is a schematic view of a configuration of a first fuel supply pipe according to a second embodiment.

FIG. 8 is a schematic view of a structure of a conventional rotary kiln.

In the drawings: 1—kiln body, 11—first refractory brick, 12—second refractory brick, 13—burner brick, 14—wheel belt, 2—kiln tail cover, 21—feeding port, 22—guide tube, 3—kiln head cover, 31—discharge port, 4—bottom base, 41—supporting roller, 51—driving gear, 52—driving gear ring, 53—motor, 54—reducer, 6—combustion component, 61—burner, 62—branch pipe, 63—fan, 64—valve, 7—first fuel supply pipe, 71—supply segment, 72—connecting segment, 73—rotating segment, 8—fuel supply source, 9—rotary joint.

### DESCRIPTION OF THE EMBODIMENTS

### Embodiment One

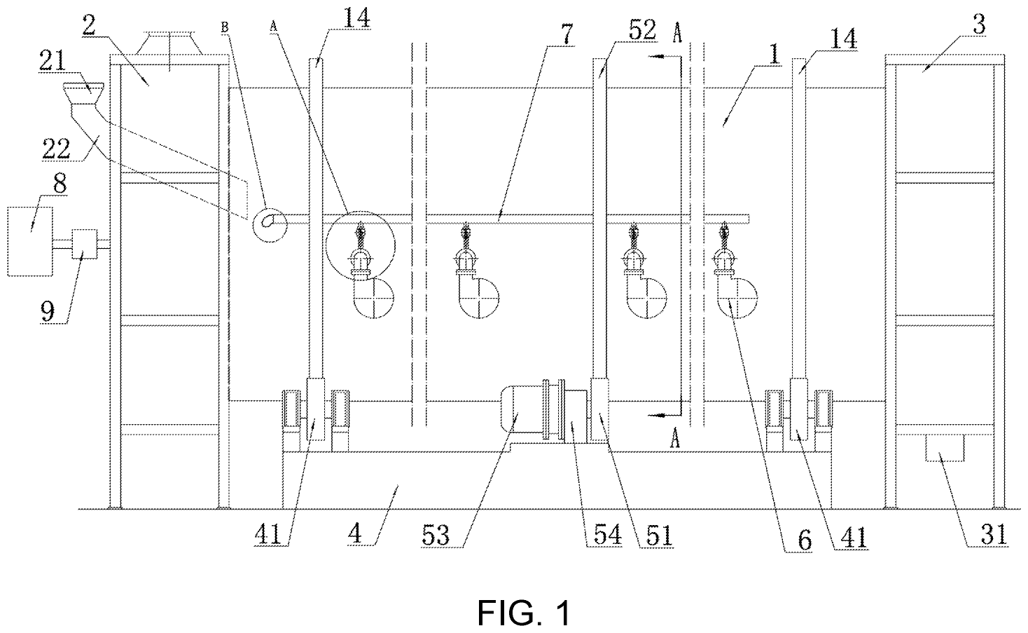

As shown in FIG. 1, a rotary kiln capable of segmented temperature control includes a kiln body 1, a kiln tail cover 2 disposed at the left end of the kiln body 1, and a kiln head cover 3 disposed at the right end of the kiln body 1. A bottom base 4 is disposed under the kiln body 1, and the bottom base 4 and the kiln body 1 are rotatably connected.

As a specific embodiment, at least two wheel belts 14 are disposed in the kiln body 1 in the embodiment. Two supporting rollers 41 are symmetrically disposed on the bottom base 4 for supporting the kiln body 1, and the supporting rollers 41 are respectively located below the wheel belts 14. The wheel belts 14 are respectively pressed against the supporting rollers 41.

A feeding port 21 is disposed on the kiln tail cover 2, and the feeding port 21 communicates with the kiln body 1 through a guide tube 22, and the guide tube extends to the inside of the kiln body 1 by penetrating the kiln tail cover 2. A discharge port 31 is disposed on the lower end of the kiln head cover 3.

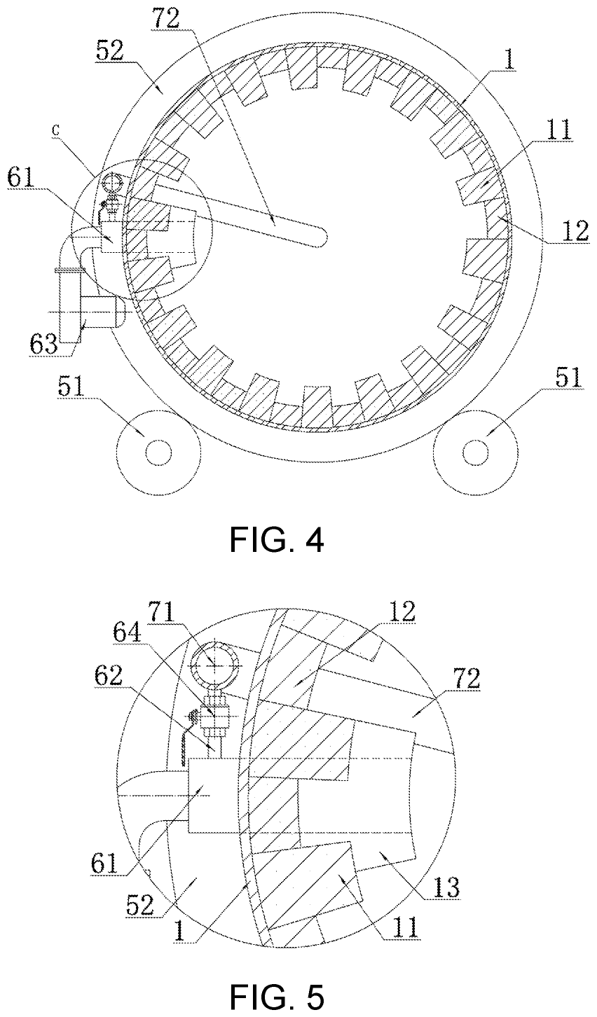

As shown in FIG. 4, first refractory bricks 11 and second refractory bricks 12 are disposed at intervals in the kiln body 1, and the first refractory bricks 11 and the second refractory bricks 12 together form a tooth-shaped structure.

A drive device for driving the kiln body 1 to rotate is disposed between the bottom base 4 and the kiln body 1. As shown in FIG. 1, the drive device includes a motor 53, a reducer 54, a driving gear 51, and a driving gear ring 52. The output shaft of the motor 53 is connected to the input shaft of the reducer 54, the output shaft of the reducer 54 is connected to the driving gear 51, and the driving gear ring 52 meshed with the driving gear 51 is disposed on the kiln body 1. Preferably, the drive gear ring 52 is disposed in the middle of the kiln body 1.

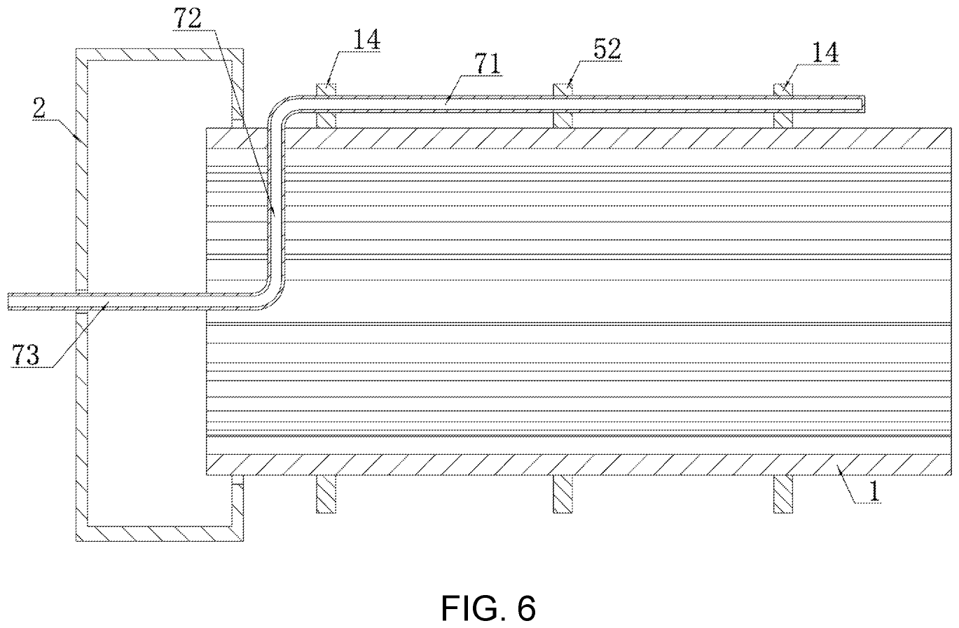

As shown in FIG. 1, FIG. 3, and FIG. 6, a first fuel supply pipe 7 is disposed on the kiln body 1, and the first fuel supply pipe 7 includes a supply segment 71, a connecting segment 72, and a rotating segment 73. The supply segment 71 is fixedly disposed on the outer side wall of the kiln body 1. The wheel belt 14 and the driving gear ring 52 are both provided with through holes allowing the supply segment 71 to pass therethrough. The rotating segment 73 is disposed in the kiln tail cover 2 and disposed coaxially with the kiln body 1, and the rotating segment 73 passes through the kiln tail cover 2 to the left and extends to the outside of the kiln tail cover 2. The connecting segment 72 is disposed inside the kiln body 1 and located on one side of the guide tube 22. One end of the connecting segment 72 is connected to the end portion of the rotating segment 73, and another end of the connecting segment 72 passes through the side wall of the kiln body 1 and is connected to the end portion of the supply segment 71. Preferably, the connecting segment 72 is disposed in a radial direction.

The rotating segment 73 of the first fuel supply pipe 7 is connected to the fuel supply source 8 through a rotatory joint 9. The structure of the rotatory joint 9 is the prior art, which is not iterated herein.

As shown in FIG. 1, multiple groups of combustion components 6 are disposed on the outer side wall of the kiln body 1 in the axial direction. As a specific implementation, four groups of combustion components 6 are disposed on the outer side wall of the kiln body 1 in the embodiment. A fuel inlet of each of the combustion components 6 is connected to the supply segment 71 of the first fuel supply pipe 7 through a branch pipe 62. The nozzle of each of the combustion components 6 passes through the side wall of the kiln body 1 and extends to the inside of the kiln body 1.

Meanwhile, the branch pipe 62 can be a hose or a hard pipe.

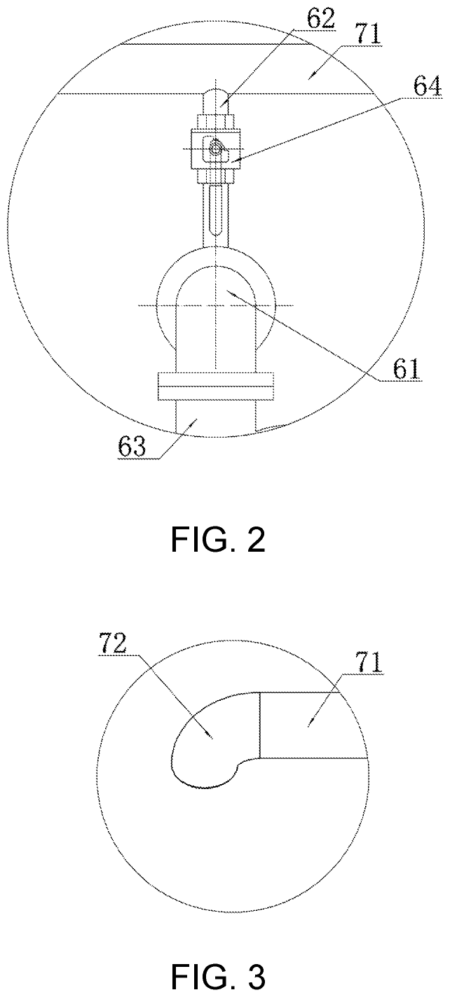

As shown in FIG. 2 and FIG. 5, each of the combustion components 6 includes a burner 61 fixedly disposed on the kiln body 1, the fuel inlet of the burner 61 of each of the combustion components 6 is connected to the supply segment 71 of the first fuel supply pipe 7 through the branch pipe 62, and a valve 64 for controlling the fuel flow is disposed on the branch pipe 62. The air inlet of the burner 61 is connected to a fan 63.

Herein, the combustion component 6 can also be an integrated combustor. However, as a preferable implementation, the combustion component 6 in the embodiment adopts a combined structure mainly because the combustion component 6 rotates with the kiln body 1 during operation. Therefore, it is better that the combustion component 6 has a small volume. If an integrated combustor is used, the radius of gyration is large, and the size of other components needs to be proportionally adjusted according to the size of the combustor, such as an increased height of the bottom base 4 and the like, and this may increase the structural size of the overall equipment.

Furthermore, to prevent the material in the kiln body 1 from blocking the burner 61 during operation and to ensure the normal operation of the burner, as shown in FIG. 5, the burner brick 13 disposed on the side wall of the kiln body 1 is higher than the inner wall of the kiln body 1. Meanwhile, the burner brick 13 and the configuration belong to the prior art and are also used in conventional kilns, which are not iterated herein.

### Embodiment Two

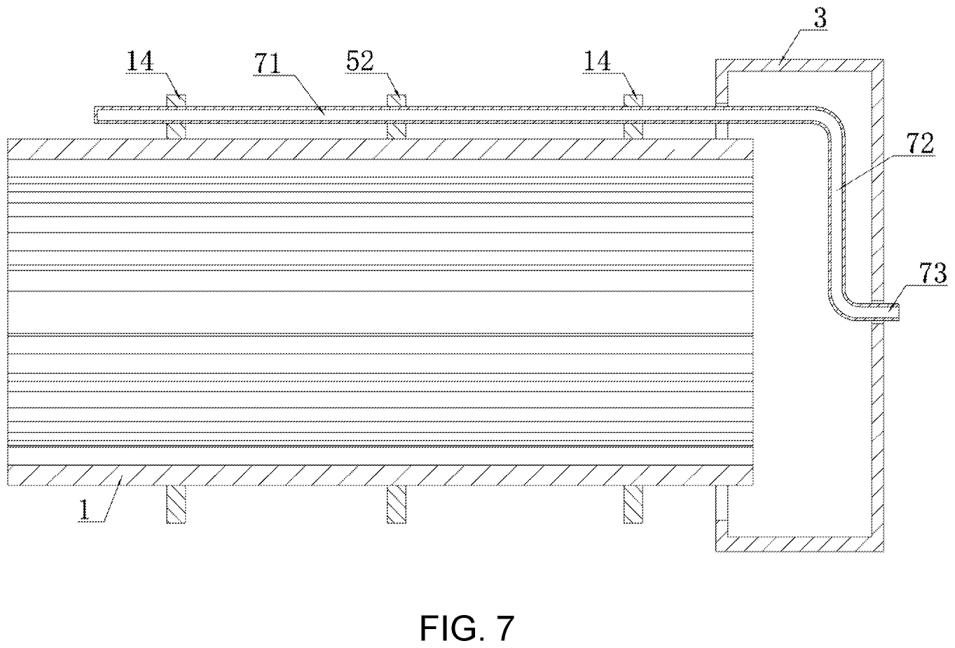

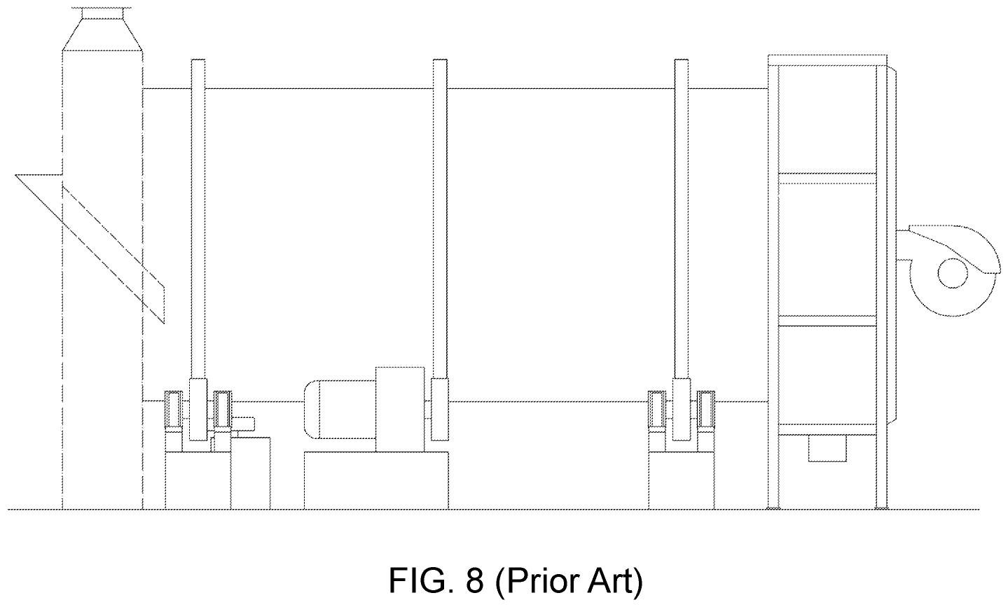

As shown in FIG. 7, the rotating segment 73 is disposed in the kiln head cover 3 and disposed coaxially with the kiln body 1, and the right end of the rotating segment 73 passes through the kiln head cover 3 and extends to the outside of the kiln head cover 3.

Furthermore, during operation, in the kiln body 1, the temperature at the feeding end is lower than the temperature at the discharge end, and when the rotating segment 73 is disposed in the kiln head cover 3, if the connecting segment 72 is still disposed in the kiln body 1, there is a safety hazard in a high temperature environment. To prevent this, as shown in FIG. 7, the connecting segment 72 is disposed in the kiln head cover 3, one end of the connecting segment 72 is connected to the end portion of the rotating segment 73, another end of the connecting segment 72 is connected to the end portion of the supply segment 71, and the end portion of the supply segment 71 extends into the kiln head cover 3. Preferably, the connecting segment 72 is arranged in a radial direction. The rest of the structure is the same as that in embodiment one.

1. A rotary kiln capable of segmented temperature control, the rotary kiln comprising a kiln body, a kiln head cover, a kiln tail cover and a bottom base, wherein a drive device is disposed between the bottom base and the kiln body, the rotary kiln further comprising a first fuel supply pipe having a supply segment, a connecting segment and a rotating segment, wherein the supply segment is fixedly disposed on an outer side wall of the kiln body, the rotating segment is disposed coaxially with the kiln body and is connected to a fuel supply source through a rotatory joint, and the supply segment communicates with the rotating segment through the connecting segment;
multiple groups of combustion components are disposed on the outer side wall of the kiln body, and a fuel inlet of each of the combustion components is connected to the supply segment of the first fuel supply pipe through a branch pipe.

2. The rotary kiln capable of segmented temperature control according to claim 1, wherein each of the combustion components comprises a burner, the fuel inlet of the burner is connected to the supply segment of the first fuel supply through the branch pipe, and an air inlet of the burner is connected to a fan.

3. The rotary kiln capable of segmented temperature control according to claim 2, wherein burner brick disposed on a side wall of the kiln body is higher than an inner side wall of the kiln body.

4. The rotary kiln capable of segmented temperature control according to claim 1, wherein a valve is disposed on the branch pipe.

5. The rotary kiln capable of segmented temperature control according to claim 1, wherein a wheel belt and a driving gear ring are disposed on the kiln body, and the wheel belt and the driving gear ring are both provided with through holes, and the supply segment passes through the through holes of the wheel belt and the driving gear ring.

6. The rotary kiln capable of segmented temperature control according to claim 1, wherein the rotating segment is disposed at a feeding end of the kiln body, one end of the connecting segment is connected to the rotating segment, and another end of the connecting segment passes through a side wall of the kiln body and is connected to the supply segment.

7. The rotary kiln capable of segmented temperature control according to claim 1, wherein the rotating segment is disposed at a discharge end of the kiln body.

8. The rotary kiln capable of segmented temperature control according to claim 7, wherein the connecting segment is disposed in the kiln head cover, and an end portion of the supply segment extends to an inside of the kiln head cover and is connected to the connecting segment.

9. The rotary kiln capable of segmented temperature control according to claim 7, wherein the connecting segment is arranged in a radial direction.

10. The rotary kiln capable of segmented temperature control according to claim 1, wherein first refractory bricks and second refractory bricks are disposed at intervals in the kiln body, and the first refractory bricks and the second refractory bricks together form a tooth-shaped structure.

11. The rotary kiln capable of segmented temperature control according to claim 6, wherein the connecting segment is arranged in a radial direction.
